(19) United States
(12) Patent Application Publication
(10) Pub. No.: US 2005/0161955 A1
(43) Pub. Date: Jul. 28, 2005

(54) Systems and methods for holding together first and second objects and fasteners for use with the systems and methods

(76) Inventor: Michael W. Hicok, Olney, MD (US)

Correspondence Address: Donald A. Kettlestrings, Esq., Suite 211, 414 Hungerford Drive, Rockville, MD, 20850, US

(21) Appl. No.: 10/762,774

(22) Filed: Jan. 23, 2004

(51) Int. Cl. E05C 3/02

(52) U.S. Cl. 292/240

(57) ABSTRACT

Systems and methods for holding together first and second objects include a first support connected to and projecting from the first object wherein the first support defines an opening therein. The second object is positioned adjacent to the first object, to the first support and to the first opening. A fastening member is movably positioned within the opening and is positioned with respect to the second object for enabling an eccentric portion of the fastening member to selectively forcibly hold the second object in fixed position with respect to the first object as the first fastening member is rotated within the opening.

### BACKGROUND OF THE INVENTION

This invention relates to fastening systems and methods and more particularly to systems and methods for holding together first and second objects using fastening members having head portions, or other portions, eccentric with respect to longitudinal axes of the fasteners.

Current systems for connecting covers to electrical panelboards and other electrical cabinets, for example, do not allow for quick and safe removal and installation of panelboard and enclosure covers. Current systems use screws, clamps, clips and brackets to hold covers to the panelboard back box.

In many of these current systems, connecting devices are installed in the wire or electrical section of the panelboard enclosure. Having these devices in the electrical section of the cabinet or enclosure creates a potential for the devices to come into contact with ungrounded, live conductors and other elements within the enclosure possibly causing electrical explosions, ground faults, or arcing which can be potentially hazardous to personnel and the equipment. Many accidents have occurred because of this design flaw. The designs of electrical panelboard and other electrical equipment cabinet covers seem to be afterthoughts because they do not self-align nor do they connect very well with the panelboards or cabinets.

The systems and methods of this invention provide a quick and secure way to attach and remove all types of electrical panelboards and electrical equipment covers. The systems of this invention can be designed to be incorporated on any type of new equipment as well as retrofitted to existing equipment. An important feature of these systems is the eccentrically designed bolt or fastener that securely connects and grounds the equipment cover to the enclosure with only a wrench required.

Once a system of this invention is installed, all components that hold the equipment covers in place are external to the equipment and, therefore, eliminate the potential for hazardous conditions. Once installed, the systems provide a quick and easy way to remove and replace electrical equipment covers because the systems are self-aligning, support the cover and provide a low-resistance ground path.

With the systems and methods of this invention, the equipment cover will always go on and come off easily no matter how many times the equipment cover is removed and replaced. The systems have few parts to wear out, and the systems are cost effective because they use parts that can be easily obtained, are inexpensive to manufacture, are easy to install and are very durable. The systems and methods of this invention provide a strong ledge or support upon which to set the cover in place before it is connected to the panelboard box or cabinet, and the ledge or support in cooperation with brackets provides exact alignment of the panel cover with respect to the cabinet. Most manufacturers of electrical panels have an inner trim panel cover that is attached to the panel prior to installation of the outer cover. The alignment provided by the systems and methods of this invention will allow manufacturers of equipment to attach the inner trim cover directly to the outer panel cover or will allow the manufacturers to build them as one piece and therefore simplify the panel design.

Although the systems and methods of this invention are described herein specifically with reference to the connection of covers to electrical cabinets, it should be understood that the systems and methods of this invention are applicable to many other situations where it is desired to firmly hold together first and second objects.

It is, therefore, an object of the present invention to provide systems and methods for holding together first and second objects.

Another object is to provide such systems and methods which use an eccentric fastening member in cooperation with a first support whereby rotation of the fastening member within the support acts to forcibly hold the second object in fixed position with respect to the first object.

A further object of the invention is the provision of such systems and methods which are particularly useful for connecting covers to electrical cabinets in a quick and safe manner.

Still another object is to provide such systems and methods which can be used to connect together many different types of first and second objects.

Yet another object of the present invention is to provide fasteners for use with the systems and methods of this invention wherein the fasteners incorporate an eccentric portion to selectively forcibly hold the second object in fixed position with respect to the first object as the fastening member is rotated with respect to a first support.

Additional objects and advantages of the invention will be set forth in part in the description which follows, and in part will be obvious from the description, or may be learned by practice of the invention. The objects and advantages are realized and attained by means of the instrumentalities and combinations particularly pointed out in the appended claims.

To achieve these and other objects, the present invention provides a system for holding together first and second objects, the system comprising: a first support connected to and projecting from the first object, the first support defining at least a first opening therein; the second object positioned adjacent to the first object, to the first support and to the first opening; a first fastening member defining a longitudinal axis and a first portion substantially perpendicular to and eccentric with respect to the axis; the first fastening member movably positioned within the first opening and positioned with respect to the second object for enabling the first eccentric portion to selectively forcibly hold the second object in fixed position with respect to the first object as the first fastening member is rotated within the first opening; and a retaining element in operative relationship with the first fastening member and with the first support for removably retaining the fastening member within the first opening.

It is to be understood that both the foregoing general description and the following detailed description are exemplary and explanatory but are not restrictive of the invention.

### BRIEF DESCRIPTION OF THE SEVERAL VIEWS OF THE DRAWINGS

The accompanying drawings, which are incorporated in and constitute a part of this specification, illustrate preferred embodiments of the invention and, together with the description, serve to explain the principles of the invention.

FIG. 1 is a perspective view showing a first invention embodiment;

FIG. 2 is a perspective view showing a second invention embodiment;

FIG. 3 is a perspective view showing a third invention embodiment;

FIG. 4 is a side elevation view of the embodiment shown in FIG. 1;

FIG. 5 is a side elevation view of the embodiment shown in FIG. 2;

FIG. 6 is a side elevation view of the embodiment shown in FIG. 3;

FIG. 7 is a perspective view of an eccentric head bolt which can be used in the invention embodiments;

FIG. 8 is a perspective view of a bolt with an eccentric projection extending from the shaft of the bolt, which can be used in the invention embodiments;

FIG. 9 is a perspective view of a T-shaped support or bracket used in the first invention embodiment;

FIG. 10 is a perspective view of a straight support or bracket used in the second invention embodiment;

FIG. 11 is a perspective view of a Z-shaped support or bracket used in the third invention embodiment;

FIG. 12 is a perspective view of an S-shaped support used in the first invention embodiment;

FIG. 13 is a perspective view of an L-shaped support used in the second invention embodiment; and

FIG. 14 is a side elevation view of another invention embodiment.

### DETAILED DESCRIPTION OF THE INVENTION

With reference now to the drawings, wherein like reference characters designate like or corresponding parts throughout the several views, there is shown first and second objects 20, 22. As illustrated herein by way of example, first object 20 is an open-front electrical panelboard box 24, and second object 22 is a cover 26 for box 24. It should be understood, however, that the systems and methods of this invention are applicable to many other situations where it is desired to firmly hold together first and second objects.

In accordance with the invention, a first support or bracket 28 is conventionally connected to and projects from first object 20, and first support 28 defines at least a first opening 30 therein.

Second object 22 is positioned adjacent to first object 20, to first support or bracket 28 and to first opening 30. A first fastening member 32 defining a longitudinal axis 34 and a first portion 36 substantially perpendicular to and eccentric with respect to axis 34 is movably positioned within first opening 30 and is positioned with respect to second object 22 for enabling first eccentric portion 36 to selectively forcibly hold second object 22 in fixed position with respect to first object 20 as first fastening member 32 is rotated within first opening 30.

A nut or similar retaining means 38 is provided in operative relationship with first fastening member 32 and with first support or bracket 28 for removably retaining fastening member 32 within first opening 30.

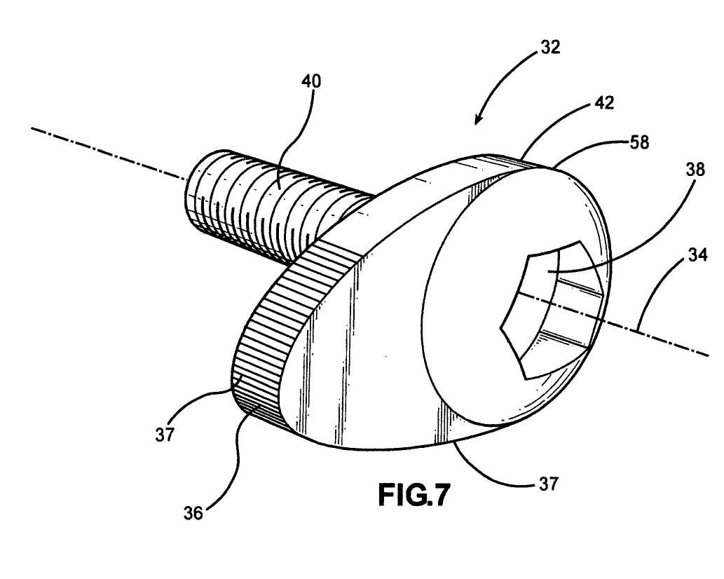

Preferably, first eccentric portion 36 defines a parabolic portion having a parabolic cross-section substantially perpendicular to axis 34. Fastening member 32 is preferably a bolt having a threaded shaft 40 and a head 42 connected to shaft 40 and wherein first eccentric portion 36 extends from head 42. See FIG. 7.

Head 42 can be a conventionally configured hex head, or bolt 32 could be designed with a screwdriver type head (e.g. flat, Phillips, square, or torx screw heads), or any other styled head to meet the requirement for desired usage.

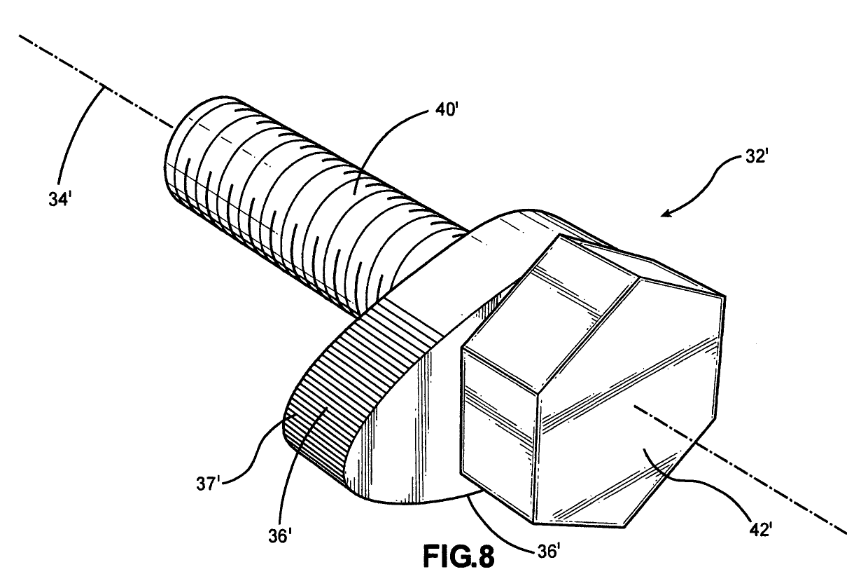

An alternative configuration is provided by fastening member 32′ having a threaded shaft 40′ and a head 42′ connected to shaft 40′ and wherein first eccentric portion 36′ extends from shaft 40′. See FIG. 8. Nut or retaining means 38 threadably engages shafts 40, 40′.

Typically, electrical panelboard box 24 defines an open front 44 having a flange 46 extending into open front 44 substantially around the perimeter of open front 44, and cover 26 is typically sized to substantially cover open front 44.

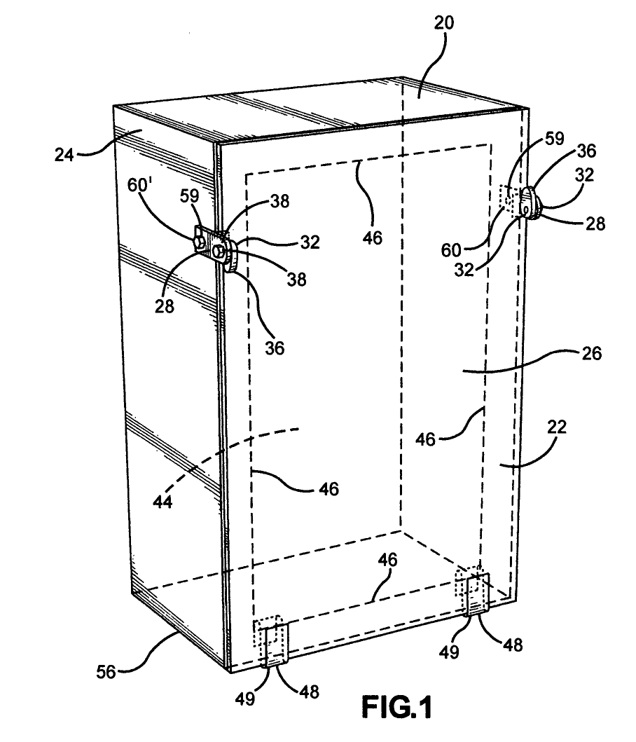

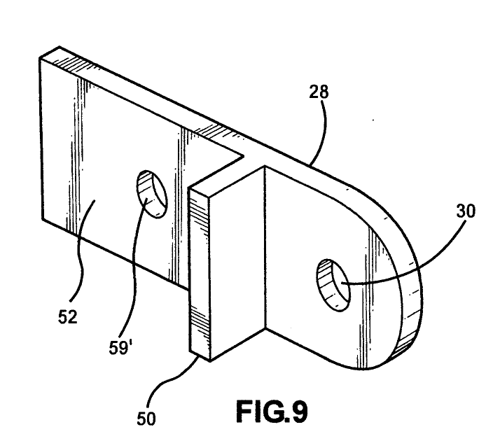

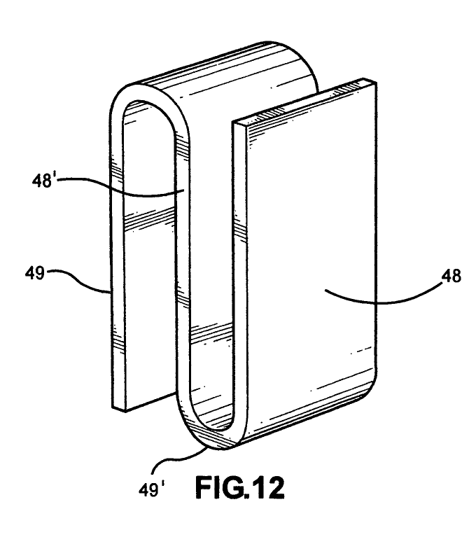

In a first embodiment of the invention, at least one substantially S-shaped support 48, see FIGS. 1 and 12, is positioned on flange 46 at the bottom of open front 44 for supporting cover 26. In this embodiment of the invention, first support or bracket 28 is preferably substantially T-shaped, see FIGS. 1 and 9, having a projection 50 connected to and extending at substantially right angles from a main body portion 52 of first support or bracket 28.

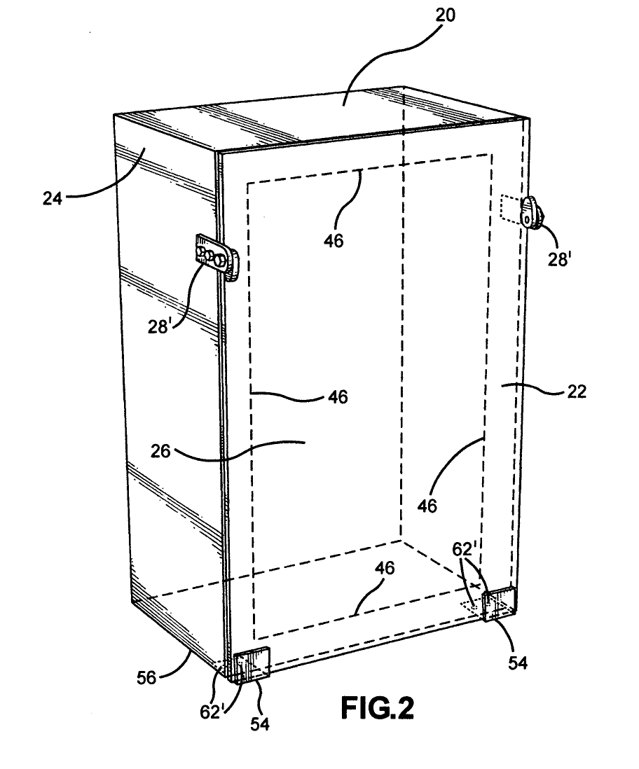

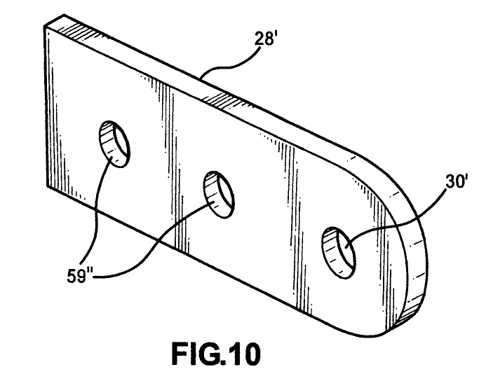

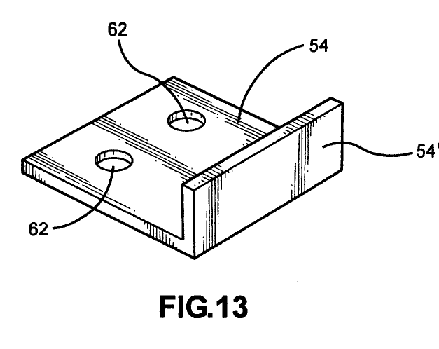

A second embodiment of the invention provides for at least one substantially L-shaped support 54 to be conventionally connected to a bottom portion 56 of box 24 for supporting cover 26. See FIGS. 2 and 13. In this embodiment of the invention, first support or bracket 28′ is substantially flat, as shown in FIG. 10. Opening 30′ is provided in support or bracket 28′ for receiving a fastening member 32, 32′ therein, as previously described.

Parabolic portions 36, 36′ each defines a substantially parabolic knurled surface 37, 37′, respectively. Head portion 42 of fastener 32 further includes a second portion 58 with a substantially semi-circular cross-section taken substantially perpendicularly to axis 34. First eccentric portion 36 preferably begins and ends in continuation with second portion 58.

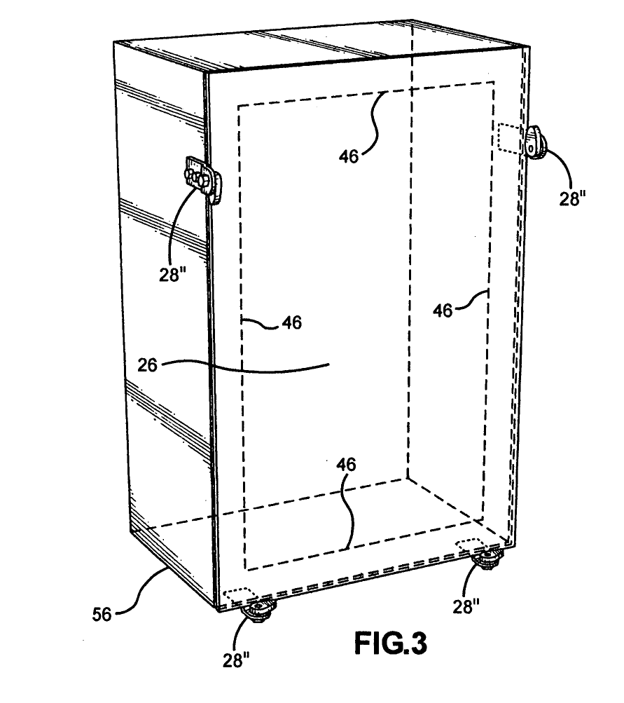

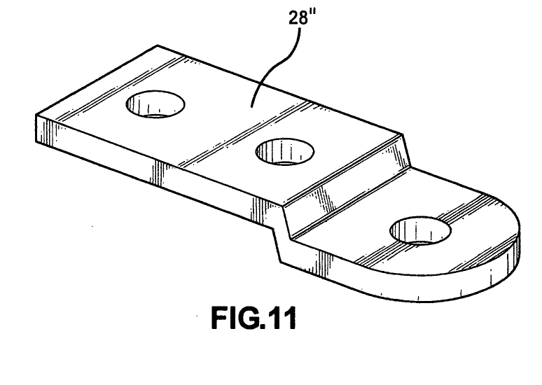

Still another embodiment of the invention provides for first support or bracket 28″ to be substantially Z-shaped to accommodate a wider cover 26. This embodiment of support or bracket 28″ is illustrated in FIGS. 3 and 11.

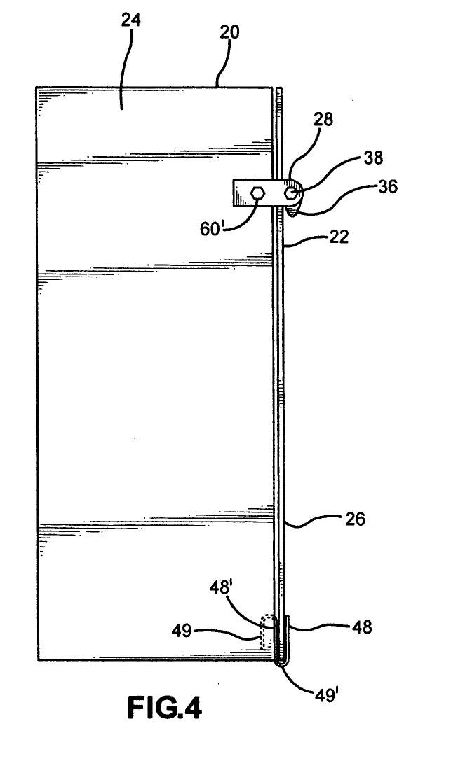

In operation and use of a first embodiment of the invention, first supports or brackets 28, which are substantially T-shaped, are used in combination with an S-shaped support or supports 48. See FIGS. 1 and 9. The thickness of projection 50 and the thickness 48′ of S-shaped support 48 are substantially the same. As a result, cover 26 is equally spaced and aligned with respect to flange 46 by the thicknesses of projection 50 and S-shaped support 48. See FIG. 4.

At least two supports or brackets 28 are conventionally connected to upper portions of opposite sides of box 24 through openings in the sides of the box by use of bolts and nuts 60, 60′ for example. Supports or brackets 28 are preferably connected from one inch to ten inches from the top of box 24 where no electrical knock outs are located. Holes or openings 59, 59′ within the sides of box 24 and within supports 28, respectively, receive bolts 60 therethrough, and self-locking nuts 60′ are used in cooperation with bolts 60 for enabling supports 28 to be fastened to the sides of box 24. The only components of the fastening systems of this invention positioned within box 24 are the heads of bolts 60 and end portions 49 of S-shaped supports 48.

S-shaped supports 48 provide a strong ledge 49′ to set cover 26 in place before cover 26 is connected to box 24. The thicknesses of projection 50 and of S-shaped supports 48 provide exact alignment of panel cover 26 with respect to box 24.

Cover 26, after being positioned onto ledges 49′ of S-shaped supports 48, is then positioned against projections 50 of T-shaped supports or brackets 28. Fastening members 32 or 32′ are then inserted through openings 30 in supports or brackets 28 with head portions 42 or 42′ positioned in front of cover 26. Retaining means or nuts 38 are then threaded onto fastening member 32 or 32′ and are tightened against supports or brackets 28 to hold fastening member 32 or 32′ in position within supports or brackets 28. Nuts 38 are preferably tightened to ten foot pounds.

Head portion 42 or 42′ is then rotated by use of a conventional tool (not shown) so that eccentric portion 36 or 36′ moves against cover 26 to forcibly hold cover 26 in fixed position with respect to box 24 as fastening member 32 or 32′ is rotated within opening 30. The contact of fastening members 32 or 32′ against cover 26 provides a positive ground path as well as tightly holding cover 26 onto box 24.

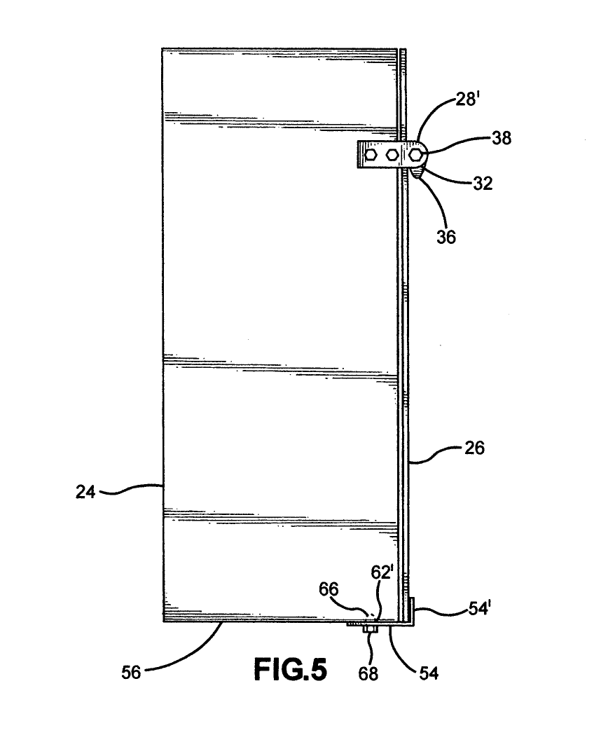

An alternative system configuration in accordance with this invention is illustrated in FIGS. 2, 5, 10 and 13 wherein substantially L-shaped supports 54 are used in combination with substantially flat first supports or brackets 28′. Preferably, at least two L-shaped supports 54 are conventionally connected to a bottom portion 56 and adjacent to corners of box 24 away from electrical knock outs. Holes 62, 62′ in L-shaped supports 54 and in bottom 56 of box 24, respectively, receive bolts 66 there-through, and self-locking nuts 68, see FIG. 5, are used in cooperation with bolts 66 to fasten supports 54 to bottom 56 of box 24.

Flange portions 54′ of supports 54 are spaced apart from flange 46 of box 24 by a distance substantially equal to the thickness of cover 26.

Supports or brackets 28′ are then conventionally attached to opposite sides of box 24 through holes 59″, as previously described with respect supports or brackets 28. Cover 26 is then first positioned onto L-shaped supports 54, and cover 26 is then moved into contact with flange 46 of box 24. Fastening members 32 or 32′ are then positioned through openings 30′ of brackets 28′, and nuts 38 are threaded onto fastening members 32 or 32′ and are tightened, as previously described, to forcibly hold cover 26 against flange 46 of box 24.

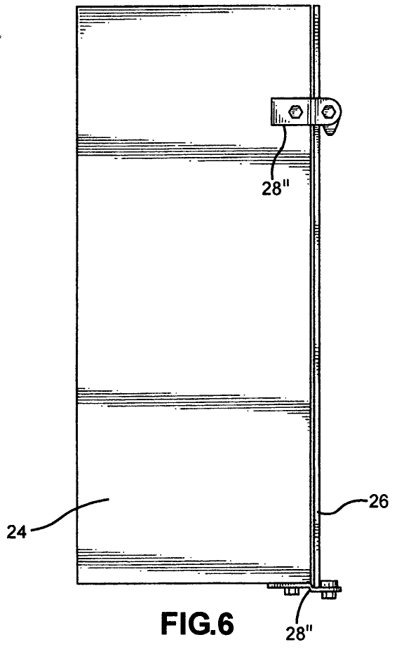

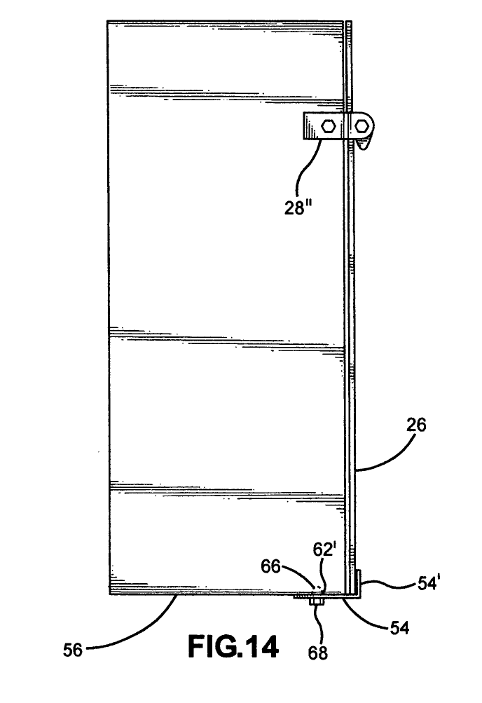

Further embodiments of the invention are illustrated in FIGS. 3, 6, 11 and 14 wherein supports or brackets 28″ are substantially Z-shaped to accommodate a wider and/or longer cover 26. Supports or brackets 28″ can be used in cooperation with L-shaped supports 54 in the same manner as previously described with respect to supports or brackets 28′ to accommodate a wider cover 26. See FIG. 14. Alternatively, supports or brackets 28″ can be used as shown in FIG. 6 wherein Z-shaped supports or brackets 28″ are also connected to the bottom of box 24 to accommodate a longer cover 26.

The invention in its broader aspects is not limited to the specific details shown and described, and departures may be made from such details without departing from the principles of the invention and without sacrificing its chief advantages.

1. A system for holding together first and second objects, said system comprising:
a first support connected to and projecting from said first object, said first support defining at least a first opening therein;
said second object positioned adjacent to said first object, to said first support and to said first opening;
a first fastening member defining a longitudinal axis and a first portion substantially perpendicular to and eccentric with respect to said axis;
said first fastening member movably positioned within said first opening and positioned with respect to said second object for enabling said first eccentric portion to selectively forcibly hold said second object in fixed position with respect to said first object as said first fastening member is rotated within said first opening; and
means in operative relationship with said first fastening member and with said first support for removably retaining said fastening member within said first opening.

2. A system as in claim 1 wherein said first eccentric portion defines a substantially parabolic portion having a cross-section substantially perpendicular to said axis.

3. A system as in claim 2 wherein said fastening member is a bolt having a threaded shaft and a head connected to said shaft and wherein said first eccentric portion extends from said head.

4. A system as in claim 3 wherein said retaining means includes a nut threadably engaging said threaded shaft.

5. A system as in claim 2 wherein said fastening member is a bolt having a threaded shaft and a head connected to said shaft and wherein said first eccentric portion extends from said shaft.

6. A system as in claim 5 wherein said retaining means includes a nut threadably engaging said threaded shaft.

7. A system as in claim 2 wherein said first object is an open-front box and said second object is a cover for said box.

8. A system as in claim 7 wherein said box defines an open front having a flange extending into said open front substantially around the perimeter of said open front and wherein said cover is sized to substantially cover said open front.

9. A system as in claim 8 further including at least one substantially S-shaped support for positioning on said flange at a bottom of said open front and for supporting said cover.

10. A system as in claim 9 wherein said first support is substantially T-shaped.

11. A system as in claim 7 further including at least one substantially L-shaped support connected to said box for supporting said cover.

12. A system as in claim 11 wherein said first support is substantially flat.

13. A system as in claim 7 wherein said box is an electrical panelboard box and wherein said box and said cover are held in electrically grounding contacting relationship with each other by said first fastening member.

14. A system as in claim 2 wherein said substantially parabolic portion defines a substantially parabolic, knurled surface.

15. A system as in claim 1 wherein said first support is substantially T-shaped.

16. A system as in claim 1 wherein said first support is substantially flat.

17. A system as in claim 1 wherein said first support is substantially Z-shaped.

18. A fastener defining a central longitudinal axis, said fastener comprising:
a shaft portion being threaded on at least a portion thereof;
a head portion connected to said shaft portion;
said head portion having a first portion, eccentric with respect to said axis, with a substantially parabolic cross-section taken perpendicularly to said axis; and
said head portion having a second portion with a substantially semi-circular cross-section taken perpendicularly to said axis.

19. A fastener as in claim 18 wherein said first portion begins and ends in continuation with said second portion.

20. A fastener as in claim 18 wherein said eccentric portion defines a substantially parabolic, knurled surface.

21. A fastener defining a central longitudinal axis, said fastener comprising:
a shaft portion being threaded on at least a portion thereof;
a head portion connected to said shaft portion; and
an additional portion connected to said shaft portion, said additional portion having a substantially parabolic cross-section taken perpendicularly to said axis.

22. A fastener as in claim 21 wherein said additional portion defines a substantially parabolic, knurled surface.

23. A method for holding together first and second objects, said method comprising the steps of:
connecting a first support to and projecting from said first object, said first support defining at least a first opening therein;
positioning said second object adjacent to said first object, to said first support and to said first opening;
providing a first fastening member defining a longitudinal axis and a first portion substantially perpendicular to and eccentric with respect to said axis;
movably positioning said first fastening member within said first opening and positioning said first fastening member with respect to said second object for enabling said first eccentric portion to selectively forcibly hold said second object in fixed position with respect to said first object as said first fastening member is rotated within said first opening; and
providing means in operative relationship with said first fastening member and with said first support for removably retaining said fastening member within said first opening.
